(19) United States
(12) Patent Application Publication
(10) Pub. No.: US 2024/0033722 A1
(43) Pub. Date: Feb. 1, 2024

(54) COMPLETE CATALYST ROASTING OR REGENERATING METHOD

(71) Applicant: ERASTEEL, Paris (FR)

(72) Inventor: Jean-Pierre DUFOUR, LES CARS (FR)

(21) Appl. No.: 18/257,555

(22) PCT Filed: Dec. 16, 2021
(86) PCT No.: PCT/EP2021/086124

§ 371 Date: Jun. 14, 2023

(30) Foreign Application Priority Data
Dec. 18, 2020 (FR) 2013719

(51) Int. Cl. B01J 38/24; B01J 38/02; B01J 27/051; B01J 21/04; B01J 23/883; B01J 23/882; B01J 23/887; B01J 27/30; B01J 23/94; B01J 19/00; B01J 19/18; F27B 7/36; F27B 7/12

(52) U.S. Cl. CPC B01J 38/24; B01J 38/02; B01J 27/051; B01J 21/04; B01J 23/883; B01J 23/882; B01J 23/8877; B01J 27/0515; B01J 27/30; B01J 23/94; B01J 19/0013; B01J 19/1812; F27B 7/36; F27B 7/12; B01J 2219/00132

(57) ABSTRACT

An industrial furnace and a method for roasting or regenerating spent petroleum catalysts. The furnace particularly includes a device to set the catalysts in motion along the bottom of the furnace to cause the catalysts to circulate from the inlet towards the outlet of the furnace; a first zone decarbonizing the spent catalysts to obtain decarbonized catalysts, followed by: a second zone including a plurality of oxygen feed devices distributed along the length of the second zone and placing the decarbonized catalysts in contact with the oxygen feed, the second zone desulfurizing the decarbonized catalysts to obtain roasted or regenerated catalysts.

The present invention relates to an industrial furnace and to a method for roasting or regenerating catalysts, in particular spent petroleum catalysts. It particularly concerns a method for roasting or regenerating spent hydrodesulfurization catalysts.

### PRIOR ART

There are two technologies (or types) of roasting furnaces for spent petroleum catalysts from desulfurization (of HDS, RDS and VRDS type):
Either: furnaces with superimposed hearth stages (multiple hearth furnaces of Herreshoff type). This technology is described in the patent by SADACI (patent application WO 2017/202909 A1). It is chiefly dedicated to the roasting of RDS/VRDS catalysts.
Rotary multiple hearth furnaces are composed of a cylindrical enclosure having a vertical axis, this enclosure contains several fixed, superimposed hearths. Arms are connected to a shaft positioned in the vertical axis of the furnace and the shaft is set in rotational motion whereby the arms become mobile relative to the hearths of the furnace. This arrangement allows stirring of the bed of catalysts contained in the furnace. The catalysts are fed into the top part of the furnace and, under the action of the mobile arms and by means of through holes in the hearths, the catalysts drop from one hearth to another until they arrive at the bottom of the furnace from which they are extracted. One variant of this furnace is that it is the hearths that are connected to the central shaft and are set in rotation, while the arms remain fixed. The hearths are lined with refractory bricks. Burners are arranged on the periphery of the circular enclosure formed of fixed refractory brickwork which closes the furnace.
The use of this type of furnace is chiefly dedicated to the roasting of RDS/VRDS catalysts, according to the following method: before roasting and during roasting, the catalyst particles are closely mixed with a sodium salt (of Na₂CO₃ type) After this mixture is fed into the roasting furnace at low temperature (<650° C.), the sodium salt reacts with the vanadium to form sodium vanadate (Na₃VO₄), thereby preventing the phenomenon of liquefaction of vanadium oxide which occurs on and after 670° C. This method subsequently allows a vanadium recovery rate of >80%. On the other hand, the addition of sodium salt has no effect on the sublimation of MoS₂. In this version of furnace and with the described method, first the removal of sulfur is incomplete (up to 2% residual sulfur) and secondly the catalyst particles are fractionated (necking phenomenon) under the effect of raking by the mechanical arms leading to a significant production of dust.
This method is costly both for return on investment and in respect of operating value since:
   The technology of the furnace is complex and the refractory linings of the furnace are chemically attacked by the sodium, this degradation being amplified by the service temperature of the furnace >800° C.,
   Operating costs are increased through the addition of reagent to ensure roasting that allows recovery of the vanadium.
   Operating costs are also increased by heating a furnace of vast volume up to 900° C. and by placing the furnace in thermal equilibrium with heating of a major mass represented by the hearths lined with refractory bricks.
   Recovery of molybdenum is low having regard to losses through sublimation of the MoS₂ species, which occurs on and after 450° C.

These disadvantages account for the increasing rarefaction of this type of furnace. This type of roasting was conducted in particular up until 2013 by the American company GCMC (patent application EP 0 771 881 A1).

It is noted that the technology of the multiple hearth furnace could be suitable for roasting HDS catalysts, but the value of the recovered metals does not allow covering of the production costs associated with this type of furnace.
Or: rotary tube furnaces equipped with powerful burners at the furnace head, these burners form the sole point of heat emission, this point also being the sole driving point of the chemical reactions involved. The furnace is tilted by a few degrees to ensure the speed of progression of the catalysts within the furnace under the effect of continuous rotation. These furnaces allow the roasting of HDS and RDS/VRDS catalysts.

With regard to HDS catalysts, for which the recovery of molybdenum is sought in priority, the catalysts to be roasted are fed into the top of the furnace without the addition of any reagent. Under the effect of the heat delivered by the burners, carbon is rapidly removed in the form of CO/CO₂. The conversion reaction of MoS₂ to MoO₃ follows thereafter and is solely heat-activated. Since the heat is dissipated along the length of the furnace, the conversion reaction is increasingly less active as it moves away from the burners. The only way to activate the conversion reaction is to increase the heat emitted by the burners, which has the consequence of a significant loss of molybdenum through vaporisation of MoS₂. In addition, sulfur is only partially removed, typically with a residual sulfur content of 2 to 3% by weight, which has a negative effect on the yield of recovered molybdenum.

With regard to RDS/VRDS catalysts which contain exogenous vanadium and for which recovery of vanadium is sought in priority, the catalysts to be roasted are fed into the top of the furnace after being closely mixed with a sodium salt (of Na₂CO₃ type) for the same aforementioned reason.

This method has the advantage of simple furnace technology, but it also has the following limits:

For HDS catalysts, for which recovery of molybdenum is sought in priority:
The losses of molybdenum are significant (about 20 to 25% of the Mo contained therein) via sublimation of MoS₂;
Desulfurization is partial with a percentage of residual sulfur in the region of 2% which is detrimental to recovery operations of molybdenum, whether these are conducted via hydrometallurgical process or pyrometallurgical process.

In respect of catalysts for which recovery of vanadium is sought, for example RDS/VRDS catalysts, and for which recovery of vanadium is given priority:
The operating costs are high having recourse to a reagent of sodium salt type and with rapid degradation of the furnace refractories through chemical attack.
Recovery of molybdenum is low having regard to losses via vaporisation of the MoS₂ species.

JP 2012/126927 describes a method in which an alkaline metal compound (sodium) is added when treating spent catalysts containing molybdenum and/or vanadium, and sulfur. The method is implemented in a rotary tube furnace comprising a single air inlet located at one end of the furnace, opposite the feed port of the spent catalysts.

No methods for roasting spent petroleum catalysts are known to the inventors which also allow the regeneration thereof.

### OBJECTS OF THE INVENTION

It is the object of the invention to solve the technical problem of providing an industrial furnace and an industrial method, in particular for the roasting or regeneration of hydrodesulfurization catalysts. It is referred to a furnace and method for roasting or regenerating catalysts.

One particular object of the present invention is to solve the technical problem of providing an industrial furnace and an industrial method for the roasting or regeneration in particular of HDS catalysts (molybdenum-cobalt and molybdenum-nickel) and/or RDS/VRDS catalysts (molybdenum-nickel-vanadium).

A further object of the present invention is to solve the technical problem of providing an industrial furnace and an industrial method for the recovery of molybdenum in spent catalysts, in particular hydrodesulfurization catalysts and more particularly of HDS type.

A further object of the present invention is to solve the technical problem of providing an industrial furnace and an industrial method for the recovery of vanadium in spent catalysts, in particular hydrodesulfurization catalysts and more particularly of RDS/VRDS type.

A still further object of the present invention is to solve the technical problem of providing a furnace and an economical roasting method that is neutral (without additives) or regenerating method of spent petroleum catalysts from hydrodesulfurization (for example of HDS type: molybdenum-cobalt and molybdenum-nickel, and RDS/VRDS type: molybdenum-nickel-vanadium) with a view to allowing optimal recovery of the metals contained in these catalysts.

A still further object of the present invention is to solve the technical problem of providing a furnace and a method allowing operations to be conducted in roasting mode of spent petroleum catalysts or regenerating mode of said catalysts.

A still further object of the present invention is to solve the technical problem of providing a furnace and a method which lower industrial costs compared with the aforementioned methods of the prior art.

### DETAILED DESCRIPTION OF THE INVENTION

The present invention allows the solving of the aforementioned technical problems.

In particular, the invention relates to an industrial furnace for the roasting or regeneration of spent petroleum catalysts, comprising:
an inlet for charging catalysts in the form of a plurality of spent solids called spent catalysts, and an outlet to discharge the catalysts in the form of a plurality of roasted or regenerated solids called roasted or regenerated catalysts, after desulfurization via exothermal reaction in the presence of oxygen;
a device to set the catalysts in motion along the bottom of the furnace, causing the catalysts to circulate from the inlet towards the outlet of the furnace;
a first zone in the vicinity of the furnace inlet which decarbonizes the spent catalysts to obtain decarbonized catalysts, followed by:
a second zone located between the first zone and the furnace outlet, said second zone comprising a plurality of oxygen feed devices distributed along the length of the second zone and placing the decarbonized catalysts in contact with the oxygen feed;
said second zone also comprising one or more flow rate variators of the oxygen feed as a function of the temperature of the catalysts moving within the second zone, said second zone desulfurizing the decarbonized catalysts to obtain roasted or regenerated catalysts; and
a device to evacuate the roasted or regenerated catalysts leaving the furnace.

The invention also relates to a method for roasting or regenerating catalysts, said method comprising:
through the inlet of a furnace, preferably a furnace such as defined in the invention, feeding catalysts in the form of a plurality of spent solids, called spent catalysts;
setting the catalysts in motion along the bottom of the furnace to cause the catalysts to circulate from the inlet towards the outlet of the furnace;
decarbonizing the spent catalysts in a first zone in the vicinity of the furnace inlet to obtain decarbonized catalysts; followed by
desulfurizing the decarbonized catalysts to obtain roasted or regenerated catalysts, desulfurization being implemented in a second zone located between the first zone and the outlet of the furnace, said second zone comprising a plurality of oxygen feed devices distributed along the length of the second zone and placing the decarbonized catalysts in contact with the oxygen feed;
desulfurization being controlled by varying the oxygen flow rate in said second zone by one or more flow rate variators of the oxygen feed as a function of the temperature of the catalysts moving within said second zone; and
evacuating the roasted or regenerated catalysts via an evacuation device at the furnace outlet.

One of the difficulties of regenerating and in particular of roasting methods in the prior art lies in the capability of the method to limit sublimation of MoS₂ since this occurs on and after 450° C.

In prior practice for catalyst roasting, it is difficult to overcome this phenomenon since, after removal of the carbon conducted in the temperature range of 600° C. to 900° C., the temperature of the furnace must be limited to below 600° C., and even preferably to below 500° C., which would lead to reduced activity of the desulfurization reaction (removing the constituent sulfur of the catalyst particles). This is contrary to the objective of sulfur removal. Faced with these contradictory phenomena, the quality of the roasted catalysts is characterized by:
a high residual sulfur content (S>2%), when the temperature in the furnace is too low;
major losses of molybdenum via sublimation of MoS₂, when the temperature in the furnace is too high.

The invention allows limiting of these phenomena and proposes an industrial method and furnace that are advantageous in this respect.

In one embodiment, the invention relates to a method for roasting spent petroleum catalysts. In particular, a roasting method generally has the main objective of recovering the metals contained in the spent petroleum catalysts. In said embodiment, roasting can be conducted up to a temperature lower than 600° C., but typically higher than 450° C.

In another embodiment, the invention relates to a method for regenerating spent petroleum catalysts. In particular a regenerating method generally has the main objective of subsequent reuse as catalysts of the spent petroleum catalysts. In said embodiment, regeneration can be conducted at a temperature lower than or equal to 450° C.

The spent petroleum (or petrochemical) catalysts used in the invention are desulfurization catalysts containing molybdenum. Typically, in said catalysts the active substance contains the chemical species MoS₂.

Typically, the spent petroleum catalysts contain sulfur and carbon.

Typically, the petroleum catalysts comprise a porous matrix, for example aluminium oxide.

In one embodiment, the catalysts treated by the furnace and method of the invention particularly comprise molybdenum and/or vanadium.

Typically, the metals (chiefly molybdenum) contained in spent petroleum catalysts are mostly recovered via hydrometallurgical process, but recovery modes also exist via pyrometallurgical process. Carbon and sulfur are detrimental for implementing these processes, and it is therefore necessary for these to be removed via roasting or regeneration treatment.

In one embodiment, the catalyst at least comprises vanadium to be separated from the other metal elements, the method being implemented under conditions preventing the presence of a liquid phase of vanadium oxide V₂O₅.

In one embodiment, the method of the invention is a roasting or regenerating method of spent petroleum catalysts, for example advantageously hydrodesulfurization catalysts e.g. of HDS and/or RDS/VRDS type.

In one embodiment, the temperature of the catalysts in the second zone is lower than 600° C.

In one embodiment, the temperature of the catalysts in the second zone is lower than or equal to 575° C., preferably lower than or equal to 550° C., and more preferably lower than or equal to 500° C.

In one embodiment, the temperature of the catalysts in the second zone is higher than or equal to 400° C., preferably higher than or equal to 450° C.

In one embodiment, the catalysts used to refine petroleum fractions are in the form of small rodlets, often in ceramic, having a length for example of 3 to 5 mm and width of approximately 1 mm. These rodlets are typically produced by extruding a ceramic paste with high aluminium oxide content (Al₂O₃), and they then undergo baking at high temperature (sintering) to impart mechanical strength thereto. Advantageously, the catalysts have a porous matrix.

In one embodiment, molybdenum (Mo) and sulfur (S) are placed in the porosities of the catalysts to from a chemical compound therein of molybdenum sulfide type (MoS₂), forming the active compound of the catalyst, (the sulfur forming this chemical species is therefore endogenous, it is also called «constituent sulfur of the catalysts»).

The catalysts are typically derived from a hydrodesulfurization reactor used to remove (exogenous) sulfur polluting petroleum fractions. When a HDS catalyst is no longer active, it typically comprises about: 15% sulfur (S), 15% carbon (C), 10% molybdenum (Mo), 2 to 3% nickel (Ni) or cobalt (Co), the remainder of the analysis being the aluminium oxide (Al₂O₃) of the matrix.

In said catalysts, the sulfur is mostly endogenous, it is therefore in the form of molybdenum sulfide (MoS₂) and is located in the catalyst particles. Conversely, the carbon is exogenous and is found in the form of a deposit on the catalyst particles.

In one embodiment, the invention concerns the roasting or regenerating of RDS/VRDS catalysts of the type molybdenum, nickel, vanadium. These catalysts typically comprise exogenous vanadium corresponding to an impurity of petroleum fractions. It is known that, when roasting these catalysts, the vanadium oxidizes to the form V₂O₅ and changes to a liquid phase on and after 650° C. At this point, the presence of this liquid phase during roasting treatment leads to two problems:
It plugs the pores of the catalyst particles and cancels the reactions involved, which is harmful for recovery operations of the metals contained in the catalysts;
It causes adhering together of the catalyst particles, which is harmful both for the recovery operations of the metals contained in the catalysts and for maintaining the integrity of the roasted or regenerated catalyst particles.

A method and a furnace according to the present invention allow these technical problems to be overcome, and at all events to be limited.

The present invention allows the recovery of metals contained in spent petroleum catalysts, in particular the molybdenum of HDS catalysts and/or the vanadium of RDS/VRDS catalysts.

Advantageously, a furnace of the invention substantially forms a tube.

In one embodiment, the furnace measures 10 to 15 m in length for a diameter of 2 to 5 m.

The furnace can be heated indirectly, for example a tube furnace with electric heating, but it is preferably heated directly, typically a tube furnace with refractory lining and heated by at least one burner. Direct heating has the advantage of minimising thermal inertia compared with indirect heating.

The burners are preferably located at the head of the tube furnace with refractory lining. Preferably, the tube furnace with refractory lining is heated by at least two burners, for example four burners. The greater the number of burners, the easier it is to fine-graduate the temperature at the head of the furnace using 0, 1, 2, 3 or all 4 burners.

In one advantageous embodiment, the furnace has a roasting or regenerating rate higher than or equal to 1 tonne of spent petroleum catalysts per hour. Advantageously, the catalyst thus roasted or regenerated has a very low sulfur content, preferably lower than or equal to 0.5% by weight relative to total catalyst weight.

In one embodiment, the motion device is a device to tilt and reciprocally rotate the bottom of the furnace on which the catalysts are charged, thereby creating tilting and reciprocal rotation of the first and second zones. Typically, the motion device imparts an oscillating motion to the furnace.

In one embodiment, the tilting of the first zone is different, and preferably more inclined than that of the second zone.

Advantageously, the furnace of the invention therefore undergoes reciprocal rotational motion combined with tilting of the bottom of the furnace. Therefore, the axis of the furnace is inclined to cause gravitational forward movement of the catalysts throughout the furnace under the effect of reciprocal rotations.

Advantageously, the speed of rotation, angle of rotation and time of reverse motion can be adjusted.

In one embodiment, the furnace of the invention is set in reciprocal rotation. For example, reciprocal rotation is implemented over an angle which remains smaller than +/−180°.

In one embodiment, the axis of the furnace is inclined, for example by a few percent (less than 10%) from the horizontal.

Typically, when the furnace is in operation, the catalysts form a moving bed of catalysts.

Advantageously, the invention allows preferably deep decarbonization and desulfurization of the spent catalysts.

Preferably, the invention allows the obtaining of very low contents of carbon (C) <0.1% and sulfur (S), typically <0.1%, whilst guaranteeing a yield of molybdenum (Mo) of >99% when leaving the roasting or regenerating line, as measured by the ratio: Weight of outgoing Mo/Weight of ingoing Mo.

In one embodiment, the method of the invention removes the sulfur and carbon in a first zone of the furnace.

The first zone of the furnace is advantageously dedicated to the removal of exogenous carbon deposited on the catalyst particles.

Advantageously, the carbon is removed by combustion according to the two following chemical reactions (1) and (2) which are active as a function of the availability of oxygen (dioxygen (O₂)) and the combustion temperature:

C+1/2O₂->CO (incomplete combustion) Reaction (1)

C+O₂->CO₂ (complete combustion) Reaction (2)

Reaction (1) occurs when the quantity of available dioxygen is low, and reaction (2) when this quantity is high, in particular when the quantity of oxygen is in greater amount than the stoichiometric amount relative to carbon, in particular when the quantity of oxygen is in an amount at least twice higher than the stoichiometric amount of carbon. In intermediate situations, both reactions can take place concurrently. In the presence of sufficient oxygen, and at a temperature of >850° C., reaction (2) is complete.

Advantageously, the carbon on the surface of the catalyst particles is removed as soon as the spent catalysts are fed into the furnace, under the effect of the heat prevailing therein. The first zone is therefore advantageously located near the inlet port of the furnace. Combustion of the carbon therefore preferably occurs before removal of the endogenous sulfur contained in the porosities of the catalyst particles.

In one embodiment, the method of the invention removes the constituent sulfur of the catalyst particles, typically of HDS and RDS/VRDS catalysts.

Advantageously, the sulfur is removed via a conversion chemical reaction at which the chemical species MoS₂ is converted to MoO₃ as per the following reaction scheme (3):

MOS₂₍ₛₒₗ₎+7/2O_{2(gas)}->MoO₃₍ₛₒₗ₎+2SO_{2(gas)} Reaction (3)

Reaction (3) is activated by heat, and by the availability of oxygen (characterized by oxygen partial pressure) closest to the catalysts. The reaction is exothermal. In the presence of oxygen (dioxygen (O₂)), on and after 100° C. the reaction becomes active and is then advantageously maintained by the exothermic process thereof for as long as oxygen is present. In the event of depletion of oxygen, the reaction ceases.

In one embodiment, the first zone does not comprise an oxygen feed device.

In one embodiment, the first zone produces a chemical reaction converting any carbon present on the surface of the catalysts to carbon monoxide.

Preferably, the catalysts are fed into the head (or inlet port) of the furnace, advantageously so that the catalyst particles pass through the flames of the burners to allow surface heating of the catalyst particles. Combustion of the exogenous carbon is carried out under the effect of the heat diffused by the burners.

Advantageously, the power of the burners is modulated so that the temperature is limited to 650° C. (surrounding temperature) over the first quarter of the length of the furnace. Advantageously, the first zone allows combustion of the carbon deposited on the surface of the catalyst particles without any other effects; sublimation of MoS₂ is therefore very limited and there is not any liquefaction of V₂O₅.

Advantageously, on account of the low roasting or regenerating temperatures and the fact that no additive is used, the furnace can be lined with an economical refractory lining of the type refractory concrete. Preferably, the inlet port of the furnace is arranged to facilitate rapid passing of the catalysts into the burner zone. Advantageously, the burning of carbon in the first zone takes place while limiting propagation of heat inside the catalyst particles to limit sublimation of MoS₂. On the front portion of the furnace, the refractory lining is shaped with a slope to accelerate the rate at which the catalysts pass into the burner zone.

In one embodiment, the angle of incline of the first zone of the furnace is greater than that of the second zone of the furnace, to increase the gravitational forward movement of the catalysts and thereby limit the residence time thereof in the decarbonizing zone.

In one embodiment, the second zone comprises several independent oxygen injection zones. Typically, the oxygen can be provided by an oxygen-containing gas, for example and economically this could be air.

Advantageously, the temperature of the catalysts is controlled by temperature control devices such as thermocouples, spaced at regular intervals over the length of the furnace, so that the thermocouples at all times are in contact with the catalysts. Therefore, advantageously, the thermocouples are always covered by the moving bed of catalysts even when reciprocal rotational motion is applied to the furnace.

Advantageously, the temperature of the catalysts in the furnace is regulated by the oxygen flow rate, thereby determining the reaction quantity since reaction (3) is exothermal.

Advantageously, the oxygen flow rate, typically the air flow rate, is adjusted so as to maintain the temperature within the catalysts below the temperature of 500° C.

In one embodiment, in the second zone, the catalysts form a bed of catalysts covering all the oxygen feed devices. Therefore, the oxygen injected by the oxygen feed devices passes through the bed of catalysts, thereby promoting contact between the oxygen and the catalysts and hence promoting the reactions (1), (2) and (3).

In one embodiment, after the first zone, the catalysts are in contact with the oxygen feed devices.

Typically, oxygen is fed in the form of air diffused through porous plugs. Preferably, irrespective of the chosen reciprocal angles of rotation, the angles of rotation of the furnace are adapted for the maintaining of permanent covering of the oxygen feed devices by the catalysts.

In one embodiment, the reciprocal rotational motion of the furnace provides homogeneous and gentle mixing of the catalysts (reducing abrasion and necking of the catalysts to a maximum) whilst preventing the generation of dust. This mixing mode therefore allows the integrity of the catalyst particles to be maintained, in particular by preventing fragmentation thereof. The integrity of the structure of the catalysts is therefore maintained, and therefore also the properties for use thereof allowing subsequent regeneration of said catalysts. Advantageously, the mixing of the invention also ensures the homogeneity of desulfurization. Advantageously, the oxygen feed substantially has access to the entire bed of catalysts and provides homogenous desulfurization made visibly possible by a homogeneous temperature. For example, therefore, the presence of local overheating is prevented, which could lead to liquefaction of V₂O₅ when RDS catalysts are being treated.

In one embodiment, the oxygen feed device comprises porous plugs over which the catalysts circulate, the oxygen being fed via circulation through said porous plugs. Preferably, the permeability of the porous plugs is such that the head loss, measured when air passes therethrough at a pressure of ingoing air of 1.6 bar absolute, as determined by the ratio between the flow rate in m³/h of air leaving the porous plugs relative to the flow rate in m³/h of air entering the porous plugs, is higher than or equal to 70%, on the understanding that the air not passing through the porous plugs is evacuated through an escape device. The porous plugs are typically composed of a material inert to oxygen and to the catalysts, under the operating conditions of the method (i.e. at the temperature used), for example they are in ceramic.

Typically, the porous plugs are connected to an oxygen source, generally air. Advantageously, the variator(s) of oxygen flow rate allow the controlling and adjusting of the oxygen flow rates fed into the furnace.

Preferably, the furnace is equipped with a probe for measuring the temperature of the bed of catalysts.

In one variant, the oxygen flow rate is regulated by an automatic unit servo-controlled for example by a probe measuring the temperature of the bed of catalysts. In another variant, the flow rate of the oxygen is adjusted manually.

In one embodiment, the oxygen feed devices are composed of porous parts called «porous plugs». Therefore, advantageously the oxygen is fed via diffusion through the oxygen feed devices.

Typically, air is injected by means of low-pressure compressors through the porous plugs so that the oxygen is made available in the immediate vicinity of the catalysts to allow the exothermal conversion reaction of MoS₂ to MoO₃.

In one embodiment, the oxygen feed devices are regularly spaced apart on the bottom of the furnace. In one embodiment, each of these oxygen feed devices is fed with low-pressure compressed air (typically 0.99 to 1.5 bar, preferably 0.99 to 1.2 bar, e.g. 1 bar) so that the compressed air is diffused throughout the catalysts. A higher pressure could lead to the catalysts being propelled inside the furnace, which is not desirable.

In one embodiment, the oxygen feed devices are arranged in three zones: one zone at the head of furnace, one in the centre of the furnace and one in the back portion of the furnace. Each of these zones, made up of its oxygen distribution network and oxygen feed devices, is independently fed with a flow of oxygen, for example by means of a low-pressure compressor. With this arrangement, it is advantageously possible to adjust the air flow rate on each of the zones, and hence to vary the air flow rate over the length of the furnace and obtain fine-controlling of the desulfurization reaction of the catalysts.

Advantageously, the feeding of oxygen at a variable flow rate by regulating the availability of oxygen close to the catalysts, allows control over the reaction quantity which, via the exothermic process of the reaction, provides control over the temperature of the catalysts.

Advantageously, contrary to roasting methods existing in the prior art, the desulfurization temperature of the catalysts in the furnace of the invention is mainly produced via the exothermic process of reaction (3) through fine-tuned regulation of oxygen availability close to the catalysts. Therefore, advantageously, the reaction temperature is regulated by the amount of oxygen fed by the oxygen feed devices, thereby providing control over the exothermic process of the reaction (and ultimately, control over temperature).

In one embodiment, the method of the present invention does not comprise the addition of an additive (the fed oxygen is not considered to be an additive). In particular, in one embodiment, the method of the present invention does not comprise the addition of a liquid or solid additive reacting with the spent petroleum catalysts.

In general, the method is conducted continuously.

Advantageously, one or more barriers e.g. in refractory concrete, of adapted height, are arranged crosswise along the length of the furnace to retain the movement of the catalysts and to increase the contact time with the oxygen fed by the oxygen feed devices.

Preferably the barriers oppose the flow of catalysts over the entire width of the moving bed of catalysts.

Typically, the catalyst evacuating device comprises an offloading orifice acting under gravity.

In one embodiment, the second zone ensures the function of post-combustion of process gases.

In one embodiment, the furnace and method of the invention comprise a gas purification system, preferably in communication with a furnace outlet and preferably positioned in the top portion of the furnace outlet.

Preferably, the gas purification system allows reducing of the content of carbon monoxide (CO)) to a level below 5 mg/Nm³, typically via oxidation to CO₂.

In one embodiment, the gas purification system comprises a filtering system in two parts:
A post-combustion chamber to oxidize carbon monoxide (CO) to carbon dioxide (CO₂),
A gas purification system via dry process to neutralise the SO₂ produced by reaction (3).

Advantageously, the post-combustion chamber (or tower) oxidizes the carbon monoxide (CO) resulting from incomplete combustion of the exogeneous carbon coating the catalysts. Typically, the corresponding chemical reaction is the following:

CO+½O₂->CO₂ Reaction (4)

Reaction (4) is only effective at a temperature higher than 850° C. with exposure to this temperature for >2 seconds. Therefore, preferably the post-combustion chamber or tower is equipped with burners to allow reaching of the reaction temperature of 850° C.

In one preferred embodiment, the furnace and method of the invention do not comprise a post-combustion tower, or the post-combustion tower is not active, since the excess oxygen diffused by the oxygen feed devices allows the performing of reaction (4). This can particularly be accounted for by the temperature differential between the catalysts located on the bottom of the furnace where the prevailing temperature is lower than 500° C., and the top portion of the furnace where the hot gases are concentrated having a temperature of between 800° C. and 900° C. Therefore, the thermodynamic conditions for the performing of reaction (4) are advantageous according to the invention.

With this additional technical advantage imparted by the furnace and method of the invention, the oxidation of carbon monoxide (CO) to carbon dioxide is near-complete which allows a CO discharge level to be obtained of <5 mg/Nm³, this being obtained without having recourse to a post-combustion tower. This advantageously allows reducing of the operating costs of the furnace and method.

The present invention also concerns an industrial system for roasting or regenerating spent catalysts, comprising a furnace of the invention.

In one embodiment, upstream of the furnace, the system comprises an automatic charging device of the catalysts into the furnace.

The roasting or regeneration method and furnace of the invention allow implementation with minimum energy consumption.

The roasting or regeneration method and furnace of the invention allow the implementation of roasting or regeneration of catalysts at low temperature (typically lower than 500° C.).

Advantageously, the roasting or regeneration method and furnace of the invention allow the recovery of spent catalysts, typically of type HDS or RDS/VRDS, via hydrometallurgical or pyrometallurgical process, and preferably guarantee a high element yield of the recovered metals: Mo>90% and V>85%.

Advantageously, the roasting or regeneration method and furnace of the invention limit sublimation of the chemical species MoS₂ and hence loss of molybdenum.

Advantageously, the roasting or regeneration method and furnace of the invention prevent the liquefaction of V₂O₅ when the catalysts concerned are RDS/VRDS catalysts.

Advantageously, the roasting or regeneration method and furnace of the invention preserve the integrity of the solids forming the catalysts, and hence prevent loss of the metals contained in the porosities of the solid catalysts. On the contrary, in the prior art methods which lead to degradation of the structure of the solids forming the catalysts, there is production of dust with the metals becoming trapped in this dust, which necessarily causes loss of recovery yield of these metals.

Advantageously, the roasting or regeneration method and furnace of the invention are highly economical and overcome the disadvantages of existing methods.

Advantageously, the roasting or regeneration method and furnace of the invention allow deep decarbonizing and desulfurizing of spent petroleum catalysts of the type HDS and RDS/VRDS in a manner such that levels of carbon (C) of <0.1% and sulfur (S) of <0.1% can be obtained.

Advantageously, the roasting or regeneration method and furnace of the invention afford minimum energy consumption since the roasting or regeneration temperature is obtained by controlling the availability of oxygen in the exothermal conversion reaction of MoS₂ to MoO₃.

Advantageously, the roasting or regeneration method or furnace of the invention, for RDS/VRDS catalysts, does not require the addition of alkaline salts (sodium salts) to obtain a high recovery yield of vanadium (>85%). In one embodiment, no alkaline salt is added. This means that no alkaline salt is intentionally added. Evidently, this embodiment includes a method in which the spent petroleum catalysts used may contain one or more alkaline salts in the form of inevitable impurities.

Advantageously, irrespective of the levels of carbon and sulfur to be removed, in the roasting or regeneration method and furnace of the invention, the adjusting of rotation speed, angle of rotation and motion reversal time of the furnace allow the roasting of all HDS-RDS/VRDS catalysts.

Advantageously, the roasting or regeneration method and furnace of the invention yield physically intact roasted or regenerated petroleum catalysts, due to low abrasion of the catalysts within the furnace. Advantageously, the roasted or regenerated catalysts of the invention exhibit substantially no abrasion and necking when the method of the invention is implemented.

Advantageously the roasting method and furnace of the invention allow the use of an economical lining, for example of sprayed refractory concrete type.

### EXAMPLES

The roasting or regeneration furnace of the invention is of cylindrical shape (or tube shape), having a size of 14 m in length and 3 m in diameter, the steel tube forming the shell of the furnace is reinforced by a self-supporting metal structure. The inner side of the steel tube is lined with refractory concrete. At the head of the furnace, an assembly of 4 low-power burners allows heating of the furnace over the first 3 metres. The catalysts are fed via a chute into the centre of the 4 burners. The tube furnace is installed with a slope of 3% from the horizontal.

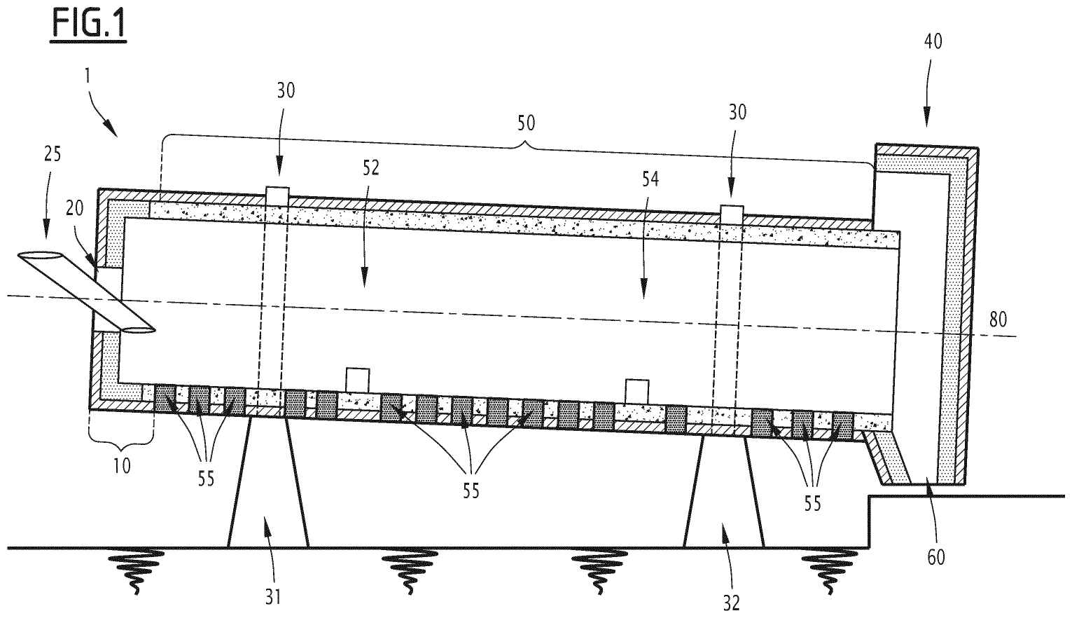

In one embodiment illustrated in FIG. 1, the roasting or regenerating furnace 1 of the invention is of cylindrical (or tube) shape, having a size of about ten metres in length and diameter of 2 to 4 m, the steel tube forming the shell of the furnace is reinforced with a self-supporting metal structure. The inner side of the steel tube is lined with a refractory concrete. At the head 20 of the furnace, an assembly of 4 low-power burners allows heating of the furnace over the first metres/centimetres. The catalysts are fed via a chute 25 in the centre of the burners. The tube furnace is installed with a slope of a few percent from the horizontal. The slope is defined by the difference in length between the supporting feet 31 and 32 of the furnace. The furnace can be set in reciprocal rotation about an axis of rotation 80. The devices 30 ensure reciprocating rotation of the furnace about the axis 80. The plurality of catalysts is fed through the inlet port 20 via the chute 25. The plurality of catalysts is deposited on the bottom of the furnace and in stationary operating mode they cover the assembly of porous plugs 55 through which the oxygen is fed, the flow rate thereof being regulated by variators (not illustrated in the diagram). By «stationary operation», it is meant when the furnace oscillates at an angle such that the porous plugs still remain covered by a thickness of catalyst particles.

The forward motion of the catalysts is regulated first by the inclined angle combined with reciprocal rotation of the furnace, and secondly by the barriers 52, 54 slowing the progression thereof. The catalysts are decarbonized in the first zone 10 then roasted or regenerated (desulfurized) in the second zone 50, and discharged through the outlet 40 via the discharge orifice 60.

1. An industrial furnace (1) for roasting or regenerating spent petroleum catalysts containing sulfur and carbon, comprising:
an inlet for catalysts in the form of a plurality of spent solids, called spent catalysts, and an outlet for the catalysts in the form of a plurality of roasted or regenerated solids, called roasted or regenerated catalysts, after desulfurization via exothermal reaction in the presence of oxygen;
a device for setting the catalysts in motion along the bottom of the furnace to cause the catalysts to circulate from the inlet towards the outlet (40) of the furnace;
a first zone in the vicinity of the inlet of the furnace decarbonizing the spent catalysts to obtain decarbonized catalysts, followed by:
a second zone located between the first zone and the outlet of the furnace, said second zone comprising a plurality of oxygen feed devices distributed along the length of the second zone and placing the decarbonized catalysts in contact with the feed oxygen;
said second zone also comprising one or more variators of the oxygen feed flow rate as a function of the temperature of the catalysts moving in the second zone, said second zone desulfurizing the decarbonized catalysts to obtain roasted or regenerated catalysts; and
a device to evacuate the roasted or regenerated catalysts on leaving the furnace.

2. The furnace according to claim 1, wherein the device for setting in motion is a device configured to tilt and reciprocally rotate the bottom of the furnace on which the catalysts are placed, thereby creating tilting and reciprocal rotation of the first and second zones.

3. The furnace according to claim 2, wherein the tilting of the first zone is different than that of the second zone.

4. The furnace according to claim 1, wherein the first zone does not comprise an oxygen feed device.

5. The furnace according to claim 1, wherein the second zone comprises several independent oxygen injection zones.

6. The furnace according to claim 1, wherein the oxygen feed device comprises porous plugs over which the catalysts circulate, the oxygen being fed via circulation through said porous plugs.

7. The furnace according to claim 1, wherein the gases located in the upper portion of the furnace have a temperature of between 800 and 900° C., the process gases thereby undergoing post-combustion.

8. The furnace according to claim 1, wherein the furnace has direct heating, or it has indirect heating and the furnace is a tube furnace.

9. A method for roasting or regenerating catalysts, comprising:
feeding catalysts containing sulfur and carbon and in the form of a plurality of spent solids called spent catalysts through an inlet of a furnace;
setting the catalysts in motion along the bottom of the furnace to cause the catalysts to circulate from the inlet towards the outlet of the furnace;
decarbonizing the spent catalysts in a first zone in the vicinity of the inlet of the furnace, to obtain decarbonized catalysts, followed by:
desulfurizing the decarbonized catalysts to obtain roasted or regenerated catalysts, desulfurization being implemented in a second zone located between the first zone and the outlet of the furnace, said second zone comprising a plurality of oxygen feed devices distributed along the length of the second zone, and placing the decarbonized catalysts in contact with the oxygen feed,
desulfurization being controlled by varying the oxygen flow rate in said second zone by one of more variators of the oxygen feed flow rate as a function of the temperature of the catalysts moving in the second zone; and
evacuating the roasted or regenerated catalysts by an evacuation device at the outlet of the furnace.

10. The method according to claim 9, wherein the temperature of the catalysts is lower than 600° C. in the second zone (50).

11. The method according to claim 9, wherein in the second zone, the catalysts form a bed of catalysts covering all the oxygen feed devices (55).

12. The method according to claim 9, wherein it is a method for roasting or regenerating spent petroleum catalysts.

13. The method according to claim 9, wherein no alkaline salt is added.

14. The furnace according to claim 3, wherein the tilting of the first zone is more inclined than that of the second zone.

15. The furnace of claim 8, wherein the furnace has direct heating comprising a tube furnace having a refractory lining that is heated by at least one burner.

16. The furnace of claim 8, wherein the furnace has indirect heating comprising a tube furnace with electric heating.

17. The method of claim 9, wherein the furnace is as defined in claim 1.

18. The method of claim 12, wherein the spent petroleum catalysts are hydrodesulfurization catalysts.

19. The method of claim 18, wherein the hydrodesulfurization catalysts are HDS and/or RDS/VRDS type.
